(19) United States
(12) Patent Application Publication
(10) Pub. No.: US 2013/0049311 A1
(43) Pub. Date: Feb. 28, 2013

(54) Wheeled Personal Grocery Basket and Cart System

(71) Applicants: Carl Metters, San Antonio, TX (US); Nicole Tetreault, San Antonio, TX (US)

(72) Inventors: Carl Metters, San Antonio, TX (US); Nicole Tetreault, San Antonio, TX (US)

(21) Appl. No.: 13/597,870

(22) Filed: Aug. 29, 2012

Related U.S. Application Data
(60) Provisional application No. 61/529,319, filed on Aug. 31, 2011.

(51) Int. Cl. B62B 3/16

(52) U.S. Cl. 280/33.998

(57) ABSTRACT

Disclosed is a separable shopping basket and cart system, comprising a wheeled basket having sidewalls and a base forming a largely rectangular structure with an open upper, which is securable to a wheeled cart adapted to accept and support the basket in an elevated position while shopping within a store. The cart comprises a wheeled base, a basket-supporting frame and a user push handle. When shopping, the basket is joined with the cart for the collection and purchasing of goods, after which the basket is separated from the cart and taken to the user's car or transported to its intended location. Purchased articles are supported within the basket during transit, while the basket wheels and extended user handle allows the basket and contents to be pulled and not physically carried. The basket is further stowable, wherein the basket walls disconnect to fold into a planar, collapsed state.

### CROSS REFERENCE TO RELATED APPLICATION

This application claims the benefit of U.S. Provisional Application No. 61/529,319 filed on Aug. 31, 2011, entitled “Eazy Cart.” The above identified patent application is herein incorporated by reference in its entirety to provide continuity of disclosure.

### BACKGROUND OF THE INVENTION

1. Field of the Invention

The present invention relates to shopping carts and carrying devices. More specifically, the present invention relates to a personal shopping cart having an independently wheeled basket that is attachable to a separate store cart for collecting and purchasing goods, whereafter the basket is separated for transporting and handling the goods during transit outside of the store.

It is well understood that shopping carts are devices provided for common use when shopping in department stores, groceries stores and other markets for the collection and transport of goods. These devices employ a wheeled frame supporting a basket area for item collection, wherein the user is not required to hand-carry the items individually or physically support a basket while shopping. Once the items are purchased, the cart is either left in the store or taken to the user's vehicle for unloading. The purchased items are generally organized in grocery bags and placed into the truck or interior of the vehicle in a loose and unsupported manner. After transporting the purchased items to the desired destination, the items must be individually lifted and transported from the vehicle, generally into a user's home or other destination where the items can be stored or utilized immediately.

Several aspects of this process are problematic for the user and for the purchased items themselves. First, the loose transport of these items allows the items to freely shift within the vehicle, leading to damaged or spilled contents due to lack of adequate support. Store bags are generally plastic or paper bags having very little means of lateral support for items placed therein; the items are therefore left insufficiently supported shifts in transporting vehicle momentum. Second, handling and supporting all of the items once the user has left the store or when transferred the items from the cart is burdensome, particularly if many items are purchased or if the user is not able to take their vehicle directly to the their intended destination (i.e. to an urban apartment or to an event away from parking). Finally, communal shopping carts are sometimes not well maintained or are left uncovered, leading to the cart becoming dirty and unsanitary. The placement of food products directly into such a shopping cart is hazardous if the cart is not clean, and can lead to illness of the user. Further still, general products placed within a dirtied cart, such as clothes or other items, can become soiled prior to their purchase. A solution to these issues related to common store carts is required, and one that provides a means of collecting and transporting products within the store and during transport therefrom.

The present invention discloses a new shopping cart system that is separable into a wheeled basket and a wheeled cart. The two assemblies are affixable to one another, whereby the basket is user-owned and the cart is store-owned. The basket provides a means of supporting purchased goods within the store, during transit and during transport to the intended destination, such as in the home or outdoor event. The basket is independently wheeled and can be pulled or lifted as desired. When in the store, the basket attaches to and is supported by a cart assembly, which supports the basket in an elevated position as is customary for grocery store carts having elevated baskets above the floor surface. The cart is left at the store and used only when shopping, allowing the basket to be cleaned and maintained by the user, and separating the communal cart aspect from directly contact with the purchased goods. The system therefore provides a means of handling, supporting and maintaining a cleanly environment for purchased and transported goods from a store.

2. Description of the Prior Art

Devices have been disclosed in the prior art that relate to grocery carts and separable basket and cart systems. These include devices that have been patented and published in patent application publications, and generally relate to stackable basket devices, means of covering or segregating an existing grocery cart or collapsible basket devices. No device provides a separable basket and cart system as disclosed in the present invention. The forgoing is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 5,918,798 to Lucas discloses a reusable and collapsible container having a rectangular base and four substantially rectangular walls. The sides and ends folds foldably joint to the perimeter of the base, while each side foldably joins to adjacent sides and includes a forty-five degree fold line therealong. The sides and base form a collapsible state and deployable state, wherein the deployable state provides an open-top container for storage of articles, particularly for use with a shopping cart and for containing groceries within the container rather than loosely within the shopping cart. The Lucas device, while providing a novel collapsible container, fails to contemplate a shopping basket that is removable from a rolling cart, wherein the basket provides a grocery store shopper with an easy means of transporting purchased goods from the grocery store and into the home.

U.S. Pat. No. 6,328,329 to Smith is another such device that discloses a collapsible shopping cart having front and rear sides connecting to a lower frame at pivot points, which allows the sides to fold downward against the lower frame and into a collapsed state. The lower frame includes four wheels and a user push handle extending upward, as with a standard shopping cart. Horizontal arms along the upper portion of the cart provide an upper frame for the cart having sides that attach at one end at a pivot point with the front of the cart and at second end via hooks that secure the horizontal members to the rear of the cart. When the hooks are disconnected, the lower and upper frame collapse into a condensed state, while the basket is comprised of a mesh material to conform to the shape of the collapsed or opened cart. The Smith device, while disclosing a collapsible shopping cart, does not include the structural elements and features of the present basket and cart assembly of the present invention.

Further, U.S. Pat. No. 6,024,527 to Soriano discloses a shopping cart having a basket and a roller support. The basket dismountable from its support to be stowed into a vehicle separately, while otherwise the basket is mounted by two lateral arms on a rolling support. Two parallel arms form deformable parallelogram system supporting the basket therebetween. The device provides a means to easily load the basket contents into a vehicle trunk by way of rotation and disconnection of the parallel arms. The Soriano device, while disclosing several embodiments for the purpose of supporting and loading groceries into a vehicle, fails to contemplate the structure or spirit of the present invention, which includes a separable basket and cart system, whereby the cart includes elements that facilitate support and carriage of grocery items outside of the store and the cart provides a means to support the basket while shopping.

U.S. Pat. No. 5,203,578 to Davidson discloses a shopping cart and container that comprises a wheeled base, an upwardly extending frame and at least one rack carried by the frame that includes a shelf for supporting at least one container. The containers are releasable securable to the shelf, thereby allowing the containers to be removed from the cart and handled independently. The preferred embodiment of the cart includes an upper and lower rack separated by a height greater than the height of the containers. The Davidson device provides an upstanding container support having a plurality of tiered racks, whereby the assembly is supported by roller wheels for wheeled support while shopping. The device does not disclose an elongated cart for supporting a large, independently wheel basket for both in-store shopping and handling when at home or outside of the store, independent of the cart support.

Finally, U.S. Pat. No. 5,427,394 to Lauto discloses a modular material carrying vehicle having a plurality of separable and stackable storage compartments. The compartments are releasably maintained in an upright and stacked configuration via a pair of elongated and tubular supports, which connect to a bottom panel having at set of roller wheels attached thereto. The tubular members enter through the base of each stacked compartment to retain their position once installed, while the wheeled base allows the plurality of stacked compartments to be moved while shopping or collecting items for placement into the compartments. The Lauto invention provides a cart with a means to secure a plurality of storage compartments stacked vertically upon one another. The present invention provides a separable and collapsible grocery basket that is adapted to be supported by a wheeled cart when in the store and independently handled when away from the store.

The present invention provides a full-sized shopping cart basket that is removable and securable to a cart assembly, whereby the two assemblies when joined provide a standard, full-sized shopping cart, and when separated the basket provides a means to transport and support purchased items during transit and over distances without carrying each item individually or lifting the basket over distances. It is submitted that the present invention is substantially divergent in design elements from the prior art, and consequently it is clear that there is a need in the art for an improvement to existing shopping cart devices. In this regard the instant invention substantially fulfills these needs.

### SUMMARY OF THE INVENTION

In view of the foregoing disadvantages inherent in the known types of shopping cart devices now present in the prior art, the present invention provides a new, separable shopping cart system, wherein the same can be utilized for providing convenience for the user when collecting and supporting items while in the store and in transit therefrom, while personally maintaining the quality of the basket as a separable and user-owned assembly.

It is therefore an object of the present invention to provide a new and improved shopping cart device and system that has all of the advantages of the prior art and none of the disadvantages.

It is another object of the present invention to provide a shopping cart device and system that includes a wheeled basket and wheeled cart, the basket being user-owned and connectable to a store-owned cart.

Another object of the present invention is to provide a shopping cart device and system that provides a user-owned basket that includes a wheeled base and a collapsible construction for reduced storage volume.

Yet another object of the present invention is to provide a shopping cart device and system that eliminates the need for communal shopping carts, whereby the user-owned basket is maintained by the user and taken to and from the store, and the store-owned cart supports the basket in an elevated position while shopping.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exploded view of the present shopping cart system, whereby the basket is being engaged on the cart.

FIG. 2 shows a side view of the shopping cart basket in connection with the cart.

FIG. 3 shows a perspective view of the present invention, wherein an embodiment of the connection means between the cart and basket is disclosed.

FIG. 4 shows a perspective view of the basket supporting a plurality of purchased items independently from the cart.

FIG. 5 shows an embodiment of the basket, whereby its structure is collapsible into a stowed state.

### DETAILED DESCRIPTION OF THE INVENTION

Reference is made herein to the attached drawings. Like reference numerals are used throughout the drawings to depict like or similar elements of the shopping cart device and system. For the purposes of presenting a brief and clear description of the present invention, the preferred embodiment will be discussed as used for supporting purchased goods while in the store and in transit therefrom. The figures are intended for representative purposes only and should not be considered to be limiting in any respect.

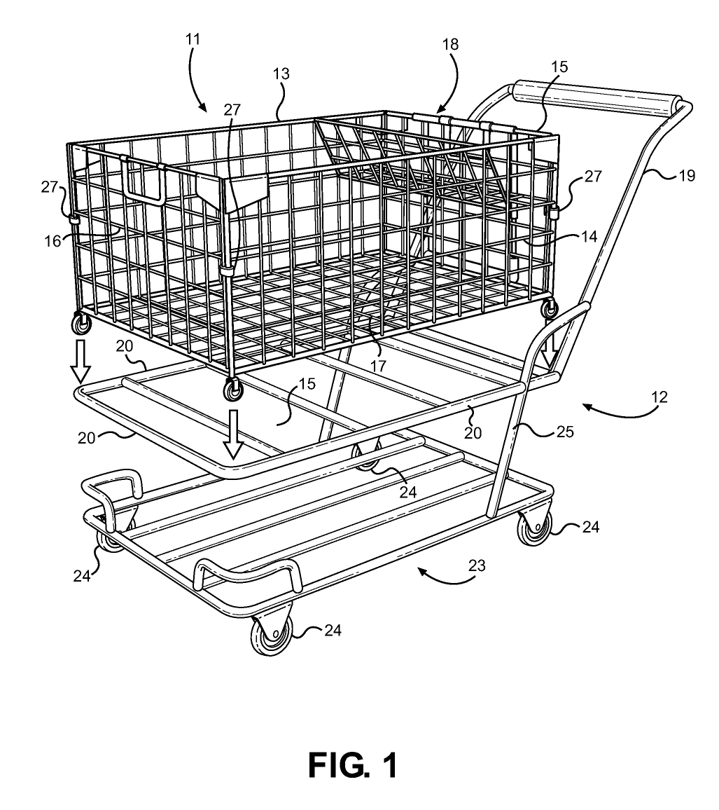

Referring now to FIG. 1, there is shown an exploded perspective view of the shopping cart system of the present invention. The system comprises a separable and securable basket assembly 11 and cart assembly 12. The cart assembly 12 comprises a wheeled base 23 having a plurality of roller wheels 24 that support a basket frame 20 in an elevated position, which further connects to a rear-mounted user handle 19 for the user to push the cart 12 and basket 11 when connected. The basket frame 20 comprises a plurality of frame members 20, 21 that form a perimeter within which the basket 11 is adapted to fit, including cross members 21 that support the basket in a level and stable position while the basket rests thereagainst. The basket assembly 11 comprises a wheeled assembly having end walls 15, 16, sidewalls 13, 14, and a base 17 forming a largely rectangular structure with an open top and an interior volume. The base of the structure includes a plurality of roller wheels 29 that allow the basket to be rollably supported. The end walls 16, 15 further comprise user handles that first allow lifting of the basket assembly from the cart 12 and further for pulling the basket along a support surface via its roller wheels 29. The interior of the basket my further include a tray area 18 for storing fragile items not meant for loose placement among the population of articles placed in the basket interior volume.

The basket 11 and cart 12 assemblies are detachable and securable to one another by way of the fitment between the basket wheels 29 and the interior boundary of the cart basket frame 20. The wheels 29 are adapted to fit within the interior of the basket frame 20 and prevent lateral movement, while the weight of the basket 11 and height of the wheels 29 secures the two together vertically. The cross members 21 support the base surface 17 of the basket, allowing the two assemblies to be quickly separable to connected as desired when entering or leaving a store. The basket and cart assemblies can be attached as just described, or alternatively a further securement means may be included to ensure no relative movement when engaged with one another; however it is submitted that the two are securably connectable without further means of attachment. In a further embodiment of the basket, the sidewalls and end walls may be separable from one another and each be hingedly attached to the basket base 17. This allows the wall of the basket to fold into a planar, stowed state when not being used. The Tray 18 is further collapsible to facilitate storage and to retract this element when not desired, as is common in most grocery cart assemblies. While in use, this embodiment of the basket includes an end wall to sidewall connector along their boundary to maintain the position of the basket in a deployed, rectangular and open state.

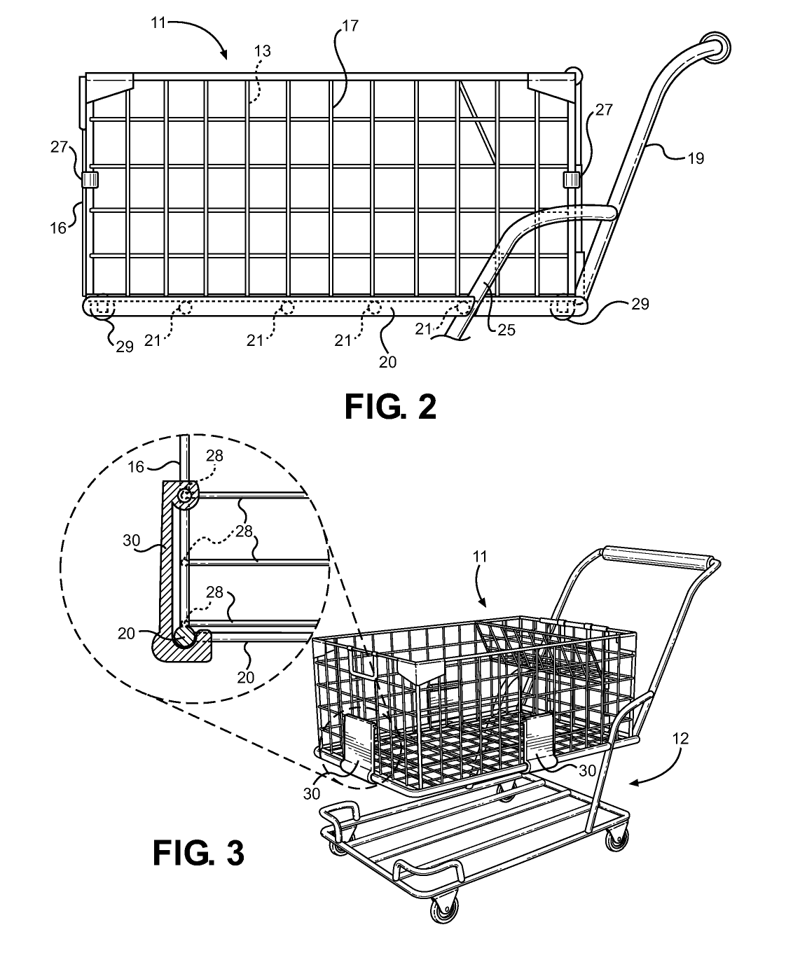

Referring now to FIG. 2, there is shown a side view of the present shopping cart system of the present invention in a working state, wherein the basket assembly 11 is securably connected to the basket frame 20 of the cart assembly. In this view, the placement of the basket wheels 29 is interior to the frame 20 boundary with excessive gaps, thereby securing the basket 11 from lateral relative movement with respect to the frame 20 while shopping or moving the assemblies. Once the basket has been lifted and placed within the frame 20, the frame cross members 21 support the basket base in the vertical direction, while the frame boundary 20 prevents lateral movement. The user is free to move the attached assemblies by way of the cart user handle 19, which extends rearward and upward toward the user, as the basket is supported in an elevated position above the ground surface, as is typical of most available grocery carts. The basket itself may comprise a number of different designs, including sidewalls 13, 17 and end walls 16, 15 having a plastic or metallic structure, an overlaid wire construction or any suitable structure deemed appropriate by one skilled in the art of shopping carts, hand carts and baskets.

Referring now to FIG. 3, there is shown perspective view and a cross section call-out view of an embodiment of the present invention, wherein the basket 11 is secured to the cart 12 using a further securement means beyond engagement of the basket wheels within the cart frame. In this embodiment, it is contemplated that a secondary securement means is disclosed, including a means of securing the basket 11 to the cart frame using a plurality of clips, latches or other temporary press-fit connector that secures to the cart frame. In its simplest form, downward-facing spring clips affixed to the base of the basket 11 may attach to the cart frame or cross members, further securing the basket location from relative movement. In another embodiment, and shown in FIG. 3, a plurality of pivotable latches 30 attaching to the walls of the basket 28 and connecting over the lower edge of the cart basket frame 20 secure the basket along its boundary to the frame 20 to prevent relatively movement or dislodging of the basket from the cart. In this embodiment, the latches 30 attach to a member of the basket sidewall or end wall and hingedly affix around the base of the cart basket frame 20. It is desired to disclose working embodiments for further securement of the basket 11 to the cart 12. It is not desired to disclose all possible variations in hardware capable of securing the basket 11 to the cart 12, and it is understood that the design of this alternative mechanism would be obvious to one skilled in the art of mechanical design and hardware.

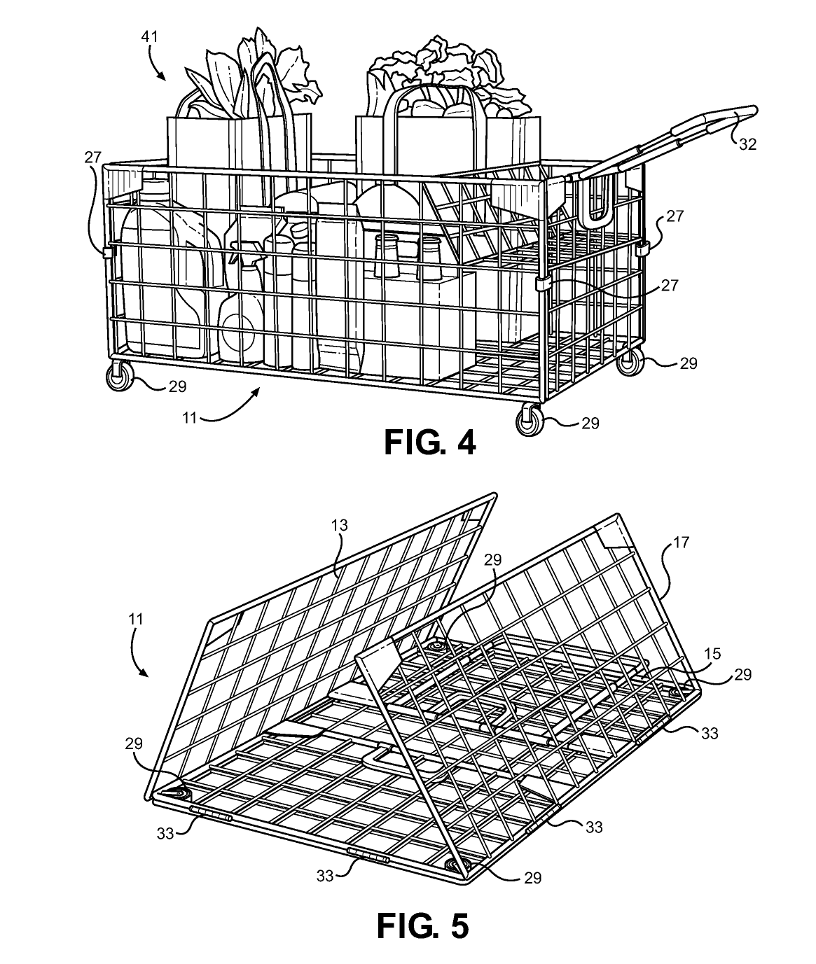

Referring now to FIG. 4, there is shown a perspective view of the basket 11 of the present invention in a working state, independent of the supporting cart and instead supporting a plurality of grocery items 41 within its interior. When separated from the cart, the basket 11 functions as an article carrier having roller wheels 29 and a user pull handle 32. An opposing handle is utilized when lifting the assembly from the ground, however during transit, the extended pull handle 32 is used as a means to pull the basket 11 without bending or slouching. In this way, the basket 11 is capable of transporting many items or heavier items from the store without requiring the user to manually carry each item. Further, the items are neatly stored within the basket interior, preventing from jostling or shifting during a car ride or while being pulled over uneven terrain. This prevents articles from becoming easily damaged, which can compromise containers and lead to spillage or the need for replacement articles. The basket 11 can be placed into a user's vehicle and then taken into his or her home for unloading. A first and second lifting handle is provided on opposing end walls of the basket to facilitate lifting into a vehicle or onto a countertop. During transit from the store, the basket 11 can also be utilized as a means of transport of the items over long distances, for instance in the city or when transporting ready-to-use goods to an event.

Referring now to FIG. 5, there is shown a view of an embodiment of the present invention, wherein the walls of the basket are separable and collapsible onto one another into a planar, stowed state having reduced overall volume. The walls are each hinged 33 from the base surface, while the end walls are separable from each sidewall 13, 17. In this way, the walls of the basket are separated and foldable onto one another into a planar state, facilitating storable when not utilizing the basket. The cart is left at the store, and after the basket is brought home it can be stored in a closet or out of the way with reduced space. In yet another embodiment that facilitates storage, it is contemplated that the roller wheels 29 of the basket may further be pivotable or hingeable inward and against the base surface of the basket.

Overall it is desired to disclose a new and improved means and method of shopping, wherein personal baskets are taken to grocery stores and mated with a store-owned cart. In this way, the basket can be kept clean as desired by the user, and the items purchased from the store can be easily transported home without individual handling or undue physical output. It is common to find users carrying multiple grocery bags on both arms when unloading vehicles. The present invention intends to eliminate this burden by providing an easily transportable, personal basket that can be unloaded in the home and not at the store location.

When an individual is finished shopping at the grocery store, it is necessary to take the bags within a shopping cart to the car and unload each bag from the cart and into the car one by one. Once that person arrives home, the bags have to then be removed one by one and taken inside. Some of the bags may have overturned during transit, become damaged or damaging the car itself. Further still, for those users without a car or who cannot drive with their items directly to their home or other intended location, individual carrying of each bag is necessary. This process can be time consuming, strenuous and potentially harmful for the user, the products and the vehicle utilized to transport the items. The present invention saves time when loading the car after making a purchase, and further reduces time unloading the car after arriving home. The disclosed basket also allows the groceries to be easily transported home and over great distances if required. All the groceries stay upright and protected within the basket, and the overall process of shopping is improved to make the experience more pleasurable and less strenuous.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A wheeled article transport, comprising:
a basket assembly;
a cart assembly;
said basket assembly comprising upstanding walls and a base forming an interior volume;
said cart assembly comprising a wheeled base, a basket support frame and a user push handle;
said basket assembly being removably supported by said cart assembly in an upright and elevated position;
said basket adapted to be supported by said cart while shopping and removed when transporting articles away from said store.

2) The device of claim 1, wherein:
said basket assembly upstanding walls further comprise end walls connecting to
sidewalls to form a largely rectangular structure with an open top.

3) The device of claim 1, wherein said basket assembly further comprises a plurality of roller wheels attached to said base.

4) The device of claim 1, wherein said basket assembly further comprises a tray area separating a portion of said basket interior volume along one of said basket walls.

5) The device of claim 1, wherein said basket assembly walls being separable from one another to collapse said walls into a stowed state against said base.

6) The device of claim 1, wherein:
said basket assembly upstanding walls further comprise end walls connecting to sidewalls to form a largely rectangular structure with an open top;
said sidewalls being removably connected to said end walls;
said sidewalls and end walls being hingedly attached to said base;
said sidewalls and end walls adapted to be collapsible into a stowed state against said base.

7) The device of claim 1, wherein:
said cart basket support frame further comprises a largely rectangular frame having cross members for supporting said basket base;
said basket assembly further comprising a plurality of roller wheels attached to said base;
said basket assembly roller wheels adapted to be positioned within said basket support frame interior, said wheels maintaining said basket position within said frame to prevent relative lateral movement.

8) The device of claim 1, wherein said basket further comprises a securement means for affixing said basket to said basket support frame.

9) The device of claim 8, wherein said basket securement means further comprises at least one spring clip for attaching to said basket support frame.

10) The device of claim 8, wherein said basket securement means further comprises at least one pivotable latch for affixing at least one basket wall to said basket support frame.

11) The device of claim 1, wherein said basket assembly further comprises a pivoting and extended user handle for transporting said basket.

12) The device of claim 1, wherein said basket assembly further comprises a first and second lifting handle for lifting said basket.

13) A method of supporting articles while shopping, comprising the steps of:
bringing a personal shopping basket into a store;
connecting said shopping basket to a store-provided cart adapted to accept and removably secure said basket in an elevated position;
shopping for items and placing said items into said basket;
removing said basket and said items from said cart upon leaving said store;
transporting said basket and said items within said basket to a desired location.

14) The method of claim 13, further comprising the steps of:
transporting said basket from said store by pulling said basket using said roller wheels and an extended handle.

15) The method of claim 13, further comprising the steps of:
stowing said basket in a condensed state when not in use.
